(19) United States
(12) Patent Application Publication
(10) Pub. No.: US 2026/0180506 A1
(43) Pub. Date: Jun. 25, 2026

(54) SYSTEM COMPRISING A SPACECRAFT AND METHOD FOR DETERMINING AN ELECTRICAL PHENOMENON OF A SOLAR GENERATOR

(71) Applicant: THALES, Meudon (FR)

(72) Inventors: Bernard Pierre Boulanger, CANNES LA BOCCA CEDEX (FR); Damien Chassoulier, CANNES LA BOCCA CEDEX (FR); Michael Notarianni, CANNES LA BOCCA CEDEX (FR)

(21) Appl. No.: 19/421,461

(22) Filed: Dec. 16, 2025

(30) Foreign Application Priority Data
Dec. 20, 2024 (FR) 2414825

(51) Int. Cl. H02S 50/00; B64G 1/44

(52) U.S. Cl. CPC H02S 50/00; B64G 1/443

(57) ABSTRACT

This disclosure relates to a system comprising a spacecraft with at least one solar generator, each solar generator including a plurality of sections and being capable of supplying the electric current to at least one electrical energy consumer of the spacecraft, at least one pair of conductors, the pairs of conductors including at least one conductor for each polarity, The spacecraft includes, for each section, at least one sensor, and at least one device for detecting an electrical phenomenon. The device for detecting an electrical phenomenon being capable of determining a common mode current for each section and/or the derivative of the common mode current for each section, and determining the presence of an electrical phenomenon and the section(s) of the solar generator affected by the electrical phenomenon.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

This disclosure relates to a system comprising a spacecraft with at least one solar generator. Furthermore, this disclosure relates to a computer-implemented method for determining an electrical phenomenon of a solar generator.

### Description of the Related Technology

Solar generators comprise solar cells with protective coverglass. In orbit, the coverglass charges positively, and, together with the solar cells, they form a capacitor that can discharge in the presence of surface plasma. This initial plasma bubble is generated by an electrostatic discharge (ESD) or following an impact of micrometeoroids and orbital debris (MMOD). This plasma is then maintained by the discharge current of the coverglass, which is concentrated on the cathode spot that emits electrons. The discharge of the coverglass thus propagates from the cathode spot. The propagation of electrostatic discharge of the coverglass on a wing of a solar generator is called a Flashover (FO). An electrostatic discharge can then create an electric arc.

U.S. Pat. No. 9,190,836 B2 uses a detection by variation of the current ratio between nominal and redundant lines, with Hall effect probes or magnetic devices.

The article “Mapping of the Appleton Anomaly Using Arc Detectors on Starlink Group 6-1 Satellites” by Starlink at the 17^{th} Spacecraft Charging Technology Conference, Palais des Papes, Avignon, France, June 17-21, discloses an arc detection system. A detector is positioned on the satellite body that does not allow the section emitting the flashover to be located, the discharges.

EP1 709 504 B1 discloses a device for protecting solar panels. The device comprises a voltage drop detection circuit and an arc extinguishing circuit.

Other simulations have been conducted on the ground, such as in Japan with the Kyushu Institute of Technologies, cf. Okumura, T et al. “Flashover plasma characteristics on 5 m2 solar array panels in a simulated plasma environment of geostationary orbit and low earth orbit”, AIAA 2010-1602, 48^{th} Aerospace Science Meeting, Orlando, USA, January 2010, and in Europe, cf. Virginie Inguimbert et al. “Measurements of the Flashover Expansion on a Real-Solar Panel—Preliminary Results of EMAGS3 Project” IEEE TRANSACTIONS ON PLASMA SCIENCE, VOL. 41, NO. 12, December 2013.

### SUMMARY OF CERTAIN INVENTIVE ASPECTS

But due to surface limitations, in particular, of simulation tests conducted on the ground, it is difficult to validate modeling tools because the architecture and modalities are very different in relation to actual use in flight.

The aim of aspects of this disclosure is then to propose a system and a method for detecting electrical phenomena of a solar generator in orbit, such as a flashover. Specifically, the aim of aspects of this disclosure is to propose a system and a method for passivation of an electric arc that can be activated autonomously or triggered after detection of the electric arc.

To this end, embodiments of this disclosure relate to a system comprising: a spacecraft with: at least one solar generator capable of generating an electric current, each solar generator being covered by a transparent protective material, each solar generator comprising a plurality of sections; at least one electrical energy consumer, each solar generator being capable of supplying the electric current to at least one electrical energy consumer of the spacecraft; at least one pair of electrical conductors associated with each section, to supply the electric current from each section of each solar generator to the respective electrical energy consumers, the pairs of conductors comprising at least one conductor for each polarity; the spacecraft comprising at least one sensor, for each section associated with at least one pair of conductors, to measure a value depending on the current(s) in the conductors; and the system comprising at least one device for detecting an electrical phenomenon of the solar generator, the device for detecting an electrical phenomenon being capable of: determining a common mode current for each section and/or the derivative of the common mode current for each section, and determining the presence of an electrical phenomenon and the section(s) of the solar generator affected by the electrical phenomenon determined from the common mode current of each section and/or the derivative of the common mode current of each section.

According to other advantageous aspects of the disclosure, the system comprises one or more of the following features, taken individually or in any technically possible combination: each solar generator comprises at least two sections; each solar generator forms a photovoltaic wing; the spacecraft is a satellite and/or a space probe; the sensor is a sensor measuring the derivative of a current, in particular a sensor comprising a toroid coil, or a current sensor; the system comprising exactly one sensor per pair of conductors; the electrical phenomenon is a discharge propagation, a secondary arc, a primary arc without discharge propagation and/or transient currents between solar generator and electric propulsion; the spacecraft is capable of passivating the determined section(s) affected, for example short-circuiting the determined section(s) affected; the device for detecting an electrical phenomenon being capable of calculating the sum of all common mode currents of each section and/or calculating the sum of all derivatives of the common mode currents of each section of a solar generator, and using the result of the calculation of the sum of all common mode currents of each section and/or the sum of all derivatives of the common mode currents of each section of a solar generator, the device for detecting an electrical phenomenon being capable of determining the type of electrical phenomenon among a detection of a discharge propagation, a secondary arc, a primary arc without discharge propagation and/or transient currents between solar generator and electric propulsion; the spacecraft comprises a power conditioning unit and the power conditioning unit comprises the sensors, at least one device for detecting an electrical phenomenon of the solar generator is arranged on the ground; at least one device for detecting an electrical phenomenon of the solar generator is arranged in the spacecraft; and/or a first part of a device for detecting an electrical phenomenon of the solar generator is arranged in the spacecraft and a second part of the device for detecting an electrical phenomenon of the solar generator is arranged on the ground.

Aspects of this disclosure also relate to a method for determining an electrical phenomenon of a solar generator of a spacecraft with: at least one solar generator capable of generating an electric current, each solar generator being covered by a transparent protective material, each solar generator comprising a plurality of sections; at least one electrical energy consumer, each solar generator being capable of supplying the electric current to at least one electrical energy consumer of the spacecraft; at least one pair of electrical conductors associated with each section, to supply the electrical energy from each section of each solar generator to the respective electrical energy consumers, the pairs of conductors comprising at least one conductor for each polarity; the method comprising: obtaining a measurement in each pair of conductors, a value depending on the current(s) in the conductors; and determining the common mode current for each section and/or the derivative of the common mode current for each section, and determining the presence of the electrical phenomenon and the section(s) of the solar generator affected by the electrical phenomenon, from the common mode current of each section and/or the derivative of the common mode current of each section.

Aspects of this disclosure also relate to a computer program including software instructions that implement a method, as defined above, when executed by a computer.

### BRIEF DESCRIPTION OF THE DRAWINGS

Aspects of this disclosure will become clearer upon reading the following description, given solely by way of non-limiting example, and made with reference to the drawings, wherein:

FIG. 1 schematically shows a system according to one embodiment;

FIG. 2 schematically shows a solar generator;

FIG. 3 schematically shows a sensor of a first embodiment;

FIG. 4 schematically shows a sensor of a second embodiment;

FIG. 5 schematically shows a sensor of another embodiment;

FIG. 6 is a top view of the sensor of FIG. 5;

FIG. 7 schematically shows a sensor of another embodiment;

FIG. 8 shows a graph of the current and the derivative of the current of a section of the solar generator emitting a FO; and

FIG. 9 shows a graph of the current and the derivative of the current of a section of the solar generator collecting the current of a FO; and

FIG. 10 shows a flowchart of a method according to one embodiment.

### DETAILED DESCRIPTION

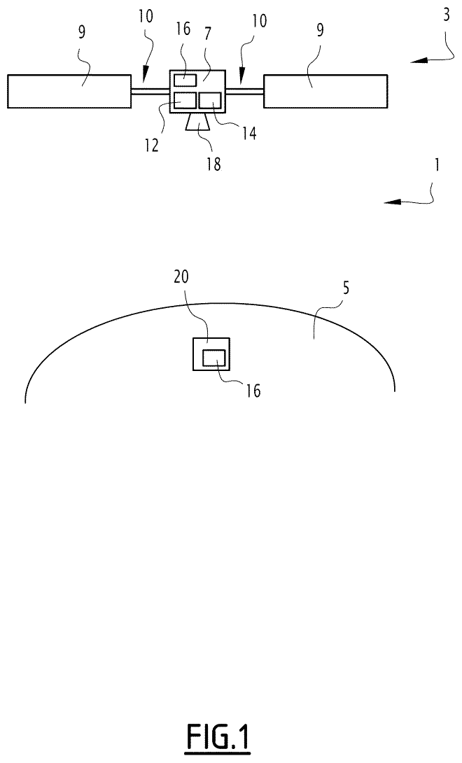

FIG. 1 schematically shows a system 1 according to one embodiment. The system 1 comprises a spacecraft 3. The spacecraft 3 orbits around the earth 5.

In one embodiment, the spacecraft 3 is a satellite.

The spacecraft 3 comprises a body 7. Furthermore, the spacecraft 3 comprises one or more solar generators 9. Each solar generator is connected to the body 7. Each solar generator is capable of generating an electric current. The term ‘solar generator’ used below corresponds to a solar generator wing.

In one embodiment, the respective solar generators 9 are connected by a solar array drive mechanism 10 (SADM) to the body 7 of the spacecraft 3. The drive mechanism 10 is capable of aligning the solar generators 9 optimally vis-à-vis the sun. For example, this mechanism comprises a motor and, in particular, a gear motor. Furthermore, the drive mechanism 10 comprises a part of the conductors transmitting the electric current generated by the respective solar generators 9 to the body 7 of the spacecraft 3.

In another embodiment, the solar generator(s) 9 are fixed to the body 7, immovable in relation to the body 7. In other words, the solar generator(s) 9 cannot be moved with respect to the body 7.

The body of the spacecraft 3 comprises at least one electrical energy consumer 12.

For example, the electrical energy consumer 12 is an observation instrument and/or a telecommunications means.

Each solar generator 9 is capable of supplying the electric current to at least one electrical energy consumer 12 of the spacecraft 3.

Furthermore, the body 7 of the spacecraft 3 comprises a power conditioning unit 14 (PCU) and/or a power bus. The power conditioning unit 14 regulates the electrical energy from the various electrical energy sources, specifically the solar generators 9 and/or batteries. In particular, the power conditioning unit 14 regulates the current and/or voltage on the power bus. The electrical energy consumer(s) 12 are connected to the power bus, for example.

The power bus is capable of supplying a current to the or each electrical energy consumer 12 such as the instruments and/or the means of telecommunication.

Optionally, the spacecraft 3 comprises one or more devices 16 for detecting an electrical phenomenon of the solar generator. For example, in one embodiment, the spacecraft 3 comprises a distinct device 16 for detecting an electrical phenomenon for each solar generator 9. In another embodiment, a single device 16 for detecting an electrical phenomenon handles the electrical phenomena for all the solar generators 9 of the spacecraft 3. In this embodiment, the device 16 is an electrical energy consumer. An electrical phenomenon is an electrical effect that is unrelated to the generation of an electric current by the solar generator 9. For example, the electrical phenomenon is a discharge propagation of the coverglass on a solar generator (Flashover), a secondary arc, a primary arc without discharge propagation and/or transient currents between solar generator and electric propulsion.

The device for detecting an electrical phenomenon 16 is capable of implementing a method for determining an electrical phenomenon of a solar generator of a spacecraft, which will be described later.

The device 16 is an electronic circuit designed to handle and/or transform data represented by electronic or physical quantities in the computer registers and/or memories into other similar data corresponding to physical data in the memory registers or other types of display devices, transmission devices or storage devices.

As specific examples, the device 16 is implemented as a programmable logic component such as an FPGA (Field Programmable Gate Array), or an integrated circuit such as an ASIC (Application Specific Integrated Circuit). In another example, the device 16 is at least implemented by analog information processing, such as a comparator-type detection circuit, that can activate an electric arc passivation circuit, for example.

In a variant, when the method is implemented as one or more software programs, i.e. as a computer program product, it is also capable of being recorded on a medium, not shown, readable by a computer. The computer-readable medium is a medium capable of storing electronic instructions and being coupled to a computer system bus. The readable medium is an optical disk, a magneto-optical disk, a ROM memory, a RAM memory, any type of non-volatile memory (e.g., FLASH or NVRAM) or a magnetic card, for example. A computer program comprising software instructions is then stored on the readable medium.

The spacecraft 3 is optionally equipped with a propulsion device 18, the propulsion device 18 is an electric propulsion device, for example, in particular a plasma propulsion unit (PPU). The propulsion device 18 is one of the electrical energy consumers of the spacecraft, for example. In one embodiment, the propulsion device 18 is connected to the power bus.

Furthermore, FIG. 1 shows a ground-based data processing unit 20 on Earth. The data processing unit is capable of receiving data from the spacecraft 3. Specifically, the data processing unit 20 is capable of storing the data received from the spacecraft 3 in a database.

The data processing unit 20 is an electronic circuit, designed to handle and/or transform data represented by electronic or physical quantities in the computer registers and/or memories into other similar data corresponding to physical data in the memory registers or other types of display devices, transmission devices, or storage devices.

As specific examples, the data processing unit 20 is implemented as a programmable logic component, such as an FPGA (Field Programmable Gate Array), or an integrated circuit, such as an ASIC (Application Specific Integrated Circuit), microprocessor, or microcontroller. In another example, the device 20 is at least implemented by analog information processing.

In a variant, when the method is implemented as one or more software programs, i.e. as a computer program product, it is also capable of being recorded on a medium, not shown, readable by a computer. The computer-readable medium is a medium capable of storing electronic instructions and being coupled to a computer system bus, for example. The readable medium is an optical disk, a magneto-optical disk, a ROM memory, a RAM memory, any type of non-volatile memory (e.g., FLASH or NVRAM), or a magnetic card, for example. A computer program comprising software instructions is then stored on the readable medium.

In one embodiment, the data processing unit 20 comprises the device for detecting an electrical phenomenon of the solar generator. In this case, the data received from the spacecraft 3 by the data processing unit 20 is the data necessary to determine the electrical phenomenon of the solar generator, at least in part.

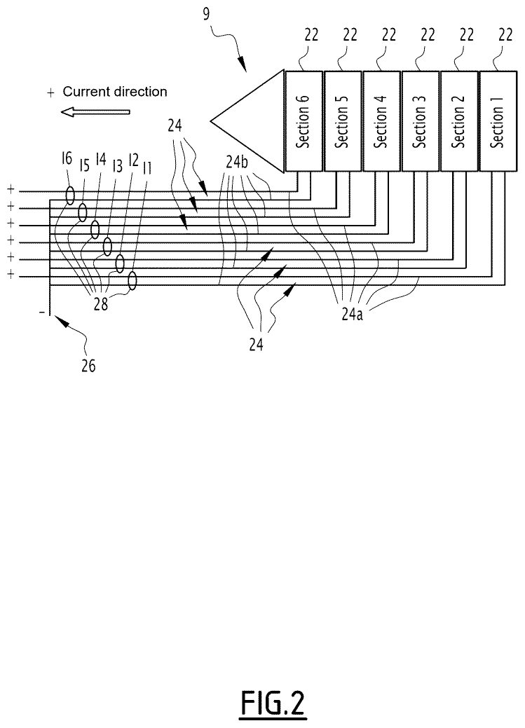

FIG. 2 schematically shows a solar generator 9.

Each solar generator 9, in particular the photovoltaic cells, is covered by a transparent protective material such as a protective glass, or protective window. The protective glass or protective window, called “cover glass” in English, is classified as being for use in space. For example, the protective glass is adapted to radiation in orbit. The protective glass has a small thickness, for example. In one embodiment, the thickness of the protective glass is between 75 micrometers and 1 millimeter. The transparent protective material is capable of covering one or more photovoltaic cells.

Each solar generator 9 comprises a plurality of sections 22. Each section comprises one or more strings. Each solar generator comprises at least 2 sections, at least 3, 4 or 5 sections, for example, in particular between 2 and 90 sections.

In one embodiment, one or more blocking diodes are mounted on each string. The blocking diodes block a reverse current in the affected string, such as in case of a shaded string, an insulation fault of a string, or in case of an EPS (Electrical Power Subsystem) failure, in the case where the current would pass from the bus to the section. For example, the diodes isolate a string from other strings of the same section, in case of a string failure, for example.

The solar generator(s) 9 are capable of supplying the electric current to the body 7 of the spacecraft 3, in particular to the power conditioning unit 12 (PCU) and/or the power bus.

At least one pair 24 of electrical conductors is associated with each section 22 of each solar generator, to supply the electric current from each section 22 to the respective electrical energy consumer(s) 12, 14, 16, 18.

Each pair 24 of conductors comprises at least one conductor of a first polarity 24a, such as “+”, and at least one conductor of a second polarity 24b, such as “−”.

According to one embodiment, for each polarity, the pair 24 of conductors comprises several redundant conductors. The redundant conductors are separated from each other, for example, at least in certain places.

The conductors of the second polarity 24b in one example are connected to a reference point of the ground 26, such as the 0V satellite.

The conductors of the first polarity 24a are connected to the power conditioning unit 14, a power bus and/or an electrical energy consumer 12, respectively, for example.

For each pair 24 of conductors, the spacecraft 3 comprises at least one sensor 28 to measure a value depending on the current(s) in the conductors 24a, 24b.

The sensor(s) 28 are outside the power conditioning unit 14.

According to one embodiment, the sensor(s) 28 are integrated into the power conditioning unit 14.

In one embodiment, the sensor 28 is a sensor measuring the derivative of a current, in particular a sensor comprising a toroid coil. Thus, the value depending on the current(s) in the conductors 24a, 24b can be a derivative of the current. The voltage measured across the toroid coil is an image of the derivative of the current passing through the sensor 28.

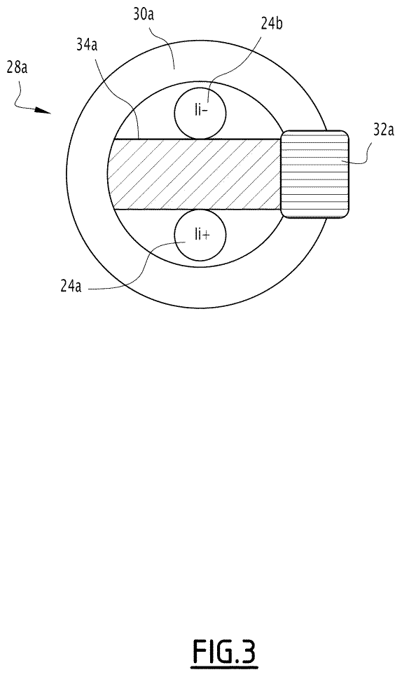

FIG. 3 schematically shows a sensor 28a of a first embodiment. The sensor 28a is capable of determining a value depending on the current(s) in the conductors 24a, 24b.

The sensor 28a comprises a ferromagnetic core 30a. The ferromagnetic core can have a variable geometry.

In FIG. 3, the ferromagnetic core 30a has a circular, annular shape or a toroid shape. Other shapes are also possible, such as the shapes described later, an “EI” shape or an “EE” shape.

A coil 32a is mounted on at least part of the ferromagnetic core 30a. At least one conductor of the first polarity 24a and at least one conductor of the second polarity 24b pass through the ferromagnetic core 30a, in particular so that the directions of the currents in the conductors 24a, 24b are opposite. In one example, all the conductors of the first polarity 24a and all conductors of the second polarity 24b pass through the ferromagnetic core 30a.

According to one embodiment, the sensor 28a comprises an isolation barrier between the conductor(s) of the first polarity 24a and the conductor(s) of the second polarity 24b, in particular to electrically isolate the conductors 24a and 24b from each other.

The sensor 24a measures the derivative of the difference of the currents (dI/dt) circulating in the conductors 24a and 24b, in particular by the coil 32a. In other words, the sensor 24a measures the derivative of the vector sum of the currents circulating in the conductors 24a and 24b.

The vector sum of the current of each pair of conductors is also called the common mode current or homopolar current. In one example, when the electrical phenomenon is detected, it is a transient common mode current.

This measurement mode enables segregation between the power circuits of the solar generator and the measurement circuits of these currents, specifically the sensors 28. Thus, the mission's reliability is not compromised where a failure of either the sensor or the power system in the form of the solar generator 9 and/or the conductors 24a, 24b propagates to other systems.

In one embodiment, the sensor 28a has an openable ferromagnetic core during assembly, to insert the conductor(s) 24a, 24b. Then the ferromagnetic core is closed.

According to one embodiment, two sensors 28a are used for each section 22: the first sensor 28a to measure a value depending on the current(s) in the conductors of the first polarity 24a, and the second sensor 28a to measure a value depending on the current(s) in the conductors of the second polarity 24b. In this case, the first sensor 28a measures the derivative of the current circulating in the conductor(s) 24a and the second sensor 28a measures the derivative of the current circulating in the conductor(s) 24b. For example, in this case, the coils 32a of the first sensor and the second sensor are connected in series to obtain the derivative of the difference of the currents (dI/dt) circulating in the conductors 24a and 24b. In another embodiment, the connection in series is made by data processing, in the device for detecting an electrical phenomenon 16, for example.

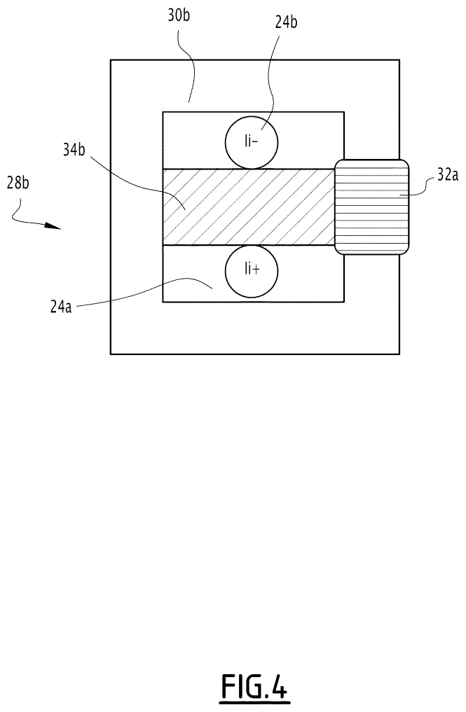

FIG. 4 schematically shows a sensor 28b of another embodiment. The sensor 28b is capable of determining a value depending on the current(s) in the conductors 24a, 24b. In the sensor 28b, the characteristics of the sensor 28b having the same functions have the same reference numbers as the embodiment of the sensor 28a of FIG. 3, except with a “b” following the number instead of an “a” (except the conductors 24a, 24b, which will have the same characteristics as in FIG. 3). Unlike FIG. 3, the sensor 28b is provided with a ferromagnetic core 30b, having the shape of a square ring.

In other embodiments, the shape of the ferromagnetic core can have other shapes, such as a hexagonal, octagonal or oval shape.

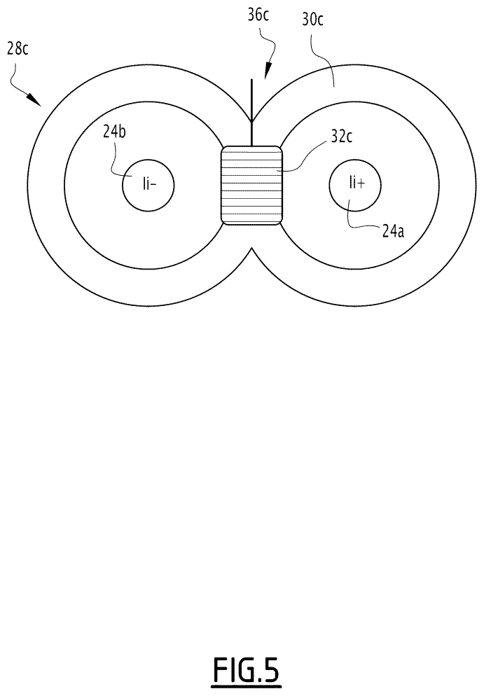

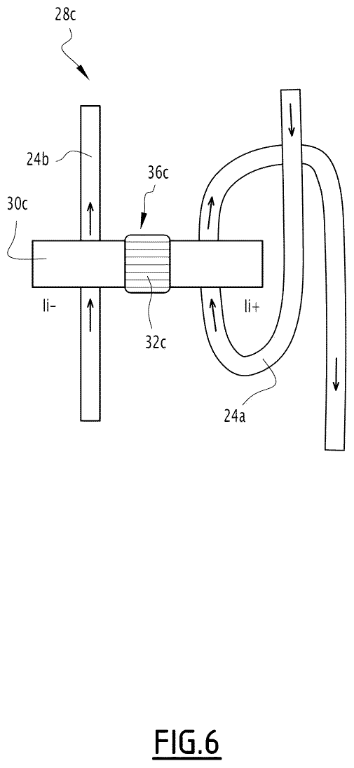

FIG. 5 schematically shows a sensor 28c of another embodiment in an axial view. The axis corresponds to the axis of the conductors 24a, 24b. FIG. 6 is a top view of the sensor 28c of FIG. 5. In the sensor 28c, the characteristics of the sensor 28c having the same functions have the same reference numbers as the embodiment of the sensor 28a of FIG. 3, except with a “c” following the number instead of an “a” (except the conductors 24a, 24b, which will have the same characteristics as in FIG. 3). The sensor 28c comprises a ferromagnetic core 30c with a double torus and a single coil 32c. In other words, the ferromagnetic core 30c comprises a first torus and a second torus. The first torus and the second torus have a common section 36c. Each torus has a circular shape. The first torus is traversed by at least one conductor of the first polarity 24a and the second torus is traversed by at least one conductor of the second polarity 24b, in particular so that the direction of the current in the conductor(s) of the first polarity 24 and the direction of the current in the conductor(s) of the second polarity 24b are approximately parallel to each other, as illustrated in FIG. 6 in particular.

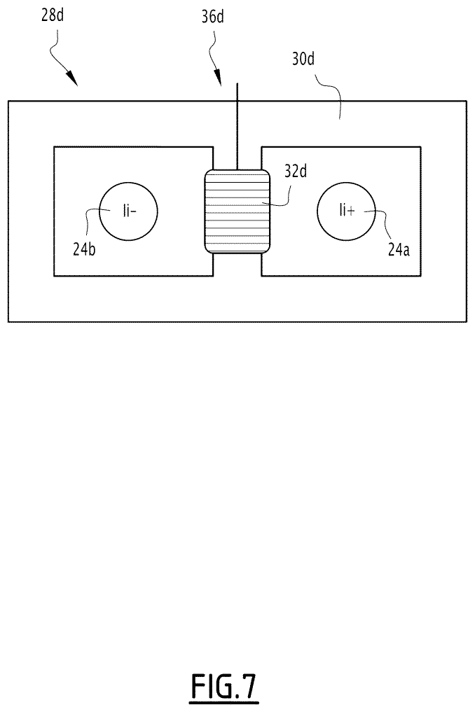

FIG. 7 schematically shows a sensor 28d of another embodiment. The sensor 28d is capable of determining a value depending on the current(s) in the conductors 24a, 24b. In the sensor 28d, the characteristics of the sensor 28c having the same functions have the same reference numbers as the embodiment of the sensor 28c of FIG. 5, except with a “d” following the number instead of a “c” (except the conductors 24a, 24b which will have the same characteristics as in FIG. 3). Unlike FIG. 3, the sensor 28d is provided with a ferromagnetic core 30d where each torus has the shape of a square ring.

According to one embodiment, all the conductors 24a, 24b associated with each section 22 pass through the sensor 28a, 28b, 28c, 28d, in particular the ferromagnetic core 30a, 30b, 30c, 30d.

In one embodiment, the sensor(s) is/are arranged, electrically, between the drive mechanism 10 (SADM) and the power conditioning unit 14 (PCU). For example, the sensor(s) is/are arranged on an electronic board in the detection device 16 that integrates a ferromagnetic core.

In another embodiment, the sensor is a current sensor. For example, each current sensor is capable of measuring the value of the current. The sensors are integrated into the power conditioning unit 14, for example. The sensor can be provided with a resistor, for example, across which a potential difference is measured and compared to a reference, such as an inductance across which the voltage variation induced by a current variation is measured.

According to one embodiment, the sensors are located in the body 7 of the spacecraft between the drive mechanism 10 (SADM) and the power conditioning unit 14 (PCU). A first current sensor is capable of measuring the current in the conductor of the first polarity 24a, for example, and a second current sensor is capable of measuring the current in the conductor of the second polarity 24b, for example. Then, the vector sum of the currents is calculated by the device 16 for detecting an electrical phenomenon, for example.

According to aspects of this disclosure, the measurements by currents in the conductors 24a, 24b, the sensors 28, 28a, 28b, 28c, 28d do not disturb the operation of the solar generator 9, nor degrade or make the mission of the spacecraft unreliable. In addition, aspects of this disclosure enable the protection of the conductors 24, 24a, 24b against arcs, between the blocking diode of the solar generator 9 and the PCU 14 comprising the SADM 10.

According to one embodiment, the current is counted positive if it flows in the conductors 24a, 24b from the solar generator to the satellite body.

During normal operation, i.e. if there is no electrical phenomenon or FO, at any time for a solar generator 9, the sum over all sections 22 of the vector sums of the currents of each pair of conductors is zero.

For example, in FIG. 2, I1+I2+I3+I4+I5+I6=0, with I1, I2, I3, I4, I5 and I6 being the vector sums of the currents of the sections of the solar generator circulating in the respective conductors 24a, 24b. More generally:

$${Σ}_{i = 1}^{N} {I}_{i} = 0 ,$$

with N the number of sections, Iᵢ being the vector sum of the currents in the pair of conductors 24 of section i.

In addition, during normal operation, the vector sum of the current of each pair of conductors is zero. In the example of FIG. 2:

$$I 1 = I 2 = I 3 = I 4 = I 5 = I 6 = 0$$

More generally Iᵢ=0, for all sections i.

Furthermore, during normal operation, each section 22 of the solar generator 9 generates a continuous current. Thus, the derivative of the vector sum of the current of each pair of conductors is zero. For example, in the example of FIG. 2

$$dI 1 / dt = dI 2 / dt = dI 3 / dt = dI 4 / dt = dI 5 / dt = dI 6 / dt = 0$$

More generally

$$\frac{{dI}_{i}}{dt} = 0$$

(the derivative of the vector sum of the current I of each pair of conductors for all sections i).

In the following, the behavior of the currents for each section during an electrostatic discharge (Flashover—FO) is explained. The FO is an electrical phenomenon.

During a propagation of electrostatic discharge (Flashover—FO), there is a section 22 of the solar generator 9 that emits the FO and one or more sections that collect(s) the FO current.

During a FO, the vector sum of the currents of the pair of conductors of the section emitting the FO, specifically with a cathode spot on this section, is positive and, for the respective sections collecting the FO current, the vector sum of the currents of the pairs of conductors is negative. Thus, during a FO, there are certain sections 22 where the vector sum of the currents in the pairs of conductors is different from zero.

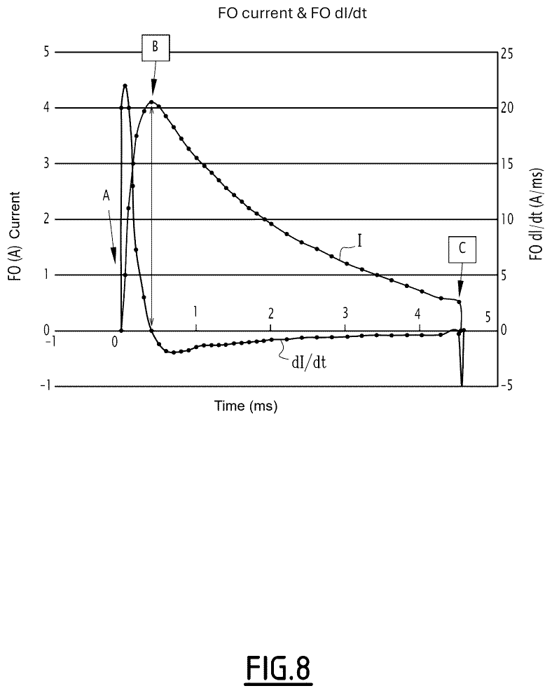

FIG. 8 shows a graph of the vector sum of the currents and the derivative of the vector sum of the currents of a section 22 that emits a FO of the solar generator 9.

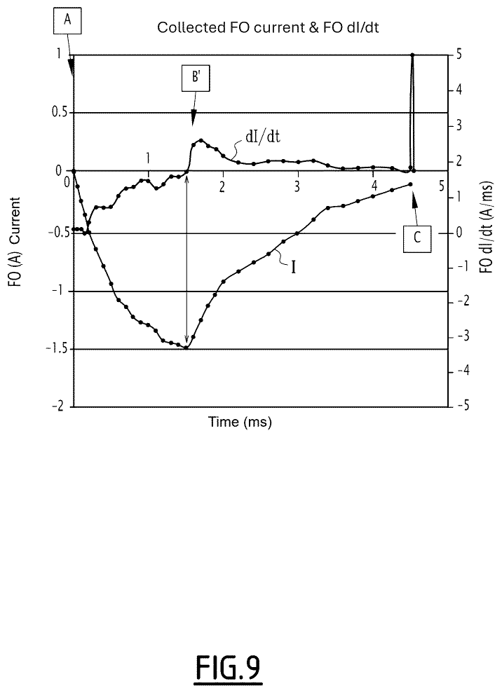

FIG. 9 shows a graph of the vector sum of the currents and the derivative of the vector sum of the currents of a section 22 that collects the FO current of the solar generator 9.

Before and during a FO, the sum of the vector sums of the currents of each section is zero. In the example of FIG. 2: I1+I2+I3+I4+I5+I6=0. More generally:

$${\sum }_{i = 1}^{N} {I}_{i} = 0. \qquad ( 1 )$$

with N the number of sections, Iᵢ being the vector sum of the currents in the pairs of conductors 24 of section i.

Moreover, before and during a FO, the sum of each derivative of the vector sum of the currents of each pair of conductors 24 of a section 22 of a solar generator 9 is equal to zero. In other words, in the example of FIG. 2: dI1/dt+dI2/dt+dI3/dt+dI4/dt+dI5/dt+dI6/dt=0. More generally:

$${\sum }_{i = 1}^{N} \frac{{dI}_{i}}{dt} = 0. \qquad ( 2 )$$

with N the number of sections, Iᵢ being the vector sum of the currents in the pairs of conductors 24 of section i and t the time.

Equations (1) and (2) apply unless there is another electrical phenomenon or another possible electrical circuit, such as a leak in a conductor or if a current is collected by the electric propulsion 18.

In FIGS. 8 and 9, the start of the FO is marked by A, the maximum (absolute) time of the vector sum of the current is marked by B and B′, respectively, and the FO extinction time is marked by C.

At the start of the FO, the derivative of the vector sum of the current of the pair of conductors 24 of the section 22 emitting a FO has a positive peak (at time A on FIG. 8), and at the FO extinction time, the derivative of the vector sum of the current of the pair of conductors 24 of the section 22 emitting a FO has a negative peak (FIG. 8).

The estimation of the maximum of the vector sum of the FO current is possible with the calculation of an integral between A and B, which corresponds to the area under the FO curve dI/dt between A and B. When there is a FO, there is only one section 22 that emits, and the other section(s) 22 collect the current.

At the start of the FO, the derivative of the vector sum of the current of the pair of conductors 24 of each section 22 collecting a FO has a negative peak (marked by A in FIG. 9), and at the FO extinction time, the derivative of the vector sum of the current of the pair of conductors 24 of the section 22 collecting a FO has a positive peak (marked by C on FIG. 9).

At point B′, the derivative of the vector sum of the current of each pair of conductors 24 of a section 22 collecting a FO is zero. It should be noted that the further the sections 22 collecting are from the section emitting the FO, the greater the time of the current peak (time B′ on FIG. 9). This corresponds to the FO propagation time between the cathode spot site of the emitting section and the different collecting sections. The time of the current peak is also called tpeak. In addition, the further the sections 22 collecting are from the emitting section, the lower the dI/dt (point A on FIG. 9) at the start.

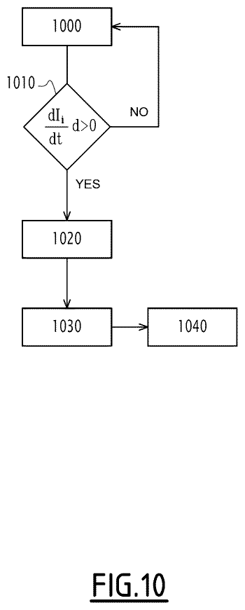

In the following, the determination of the presence of an electrical phenomenon is described. FIG. 10 shows a flowchart of a method according to one embodiment.

In a first step 1000, a common mode current for each section 22 associated with at least one pair of conductors 24a, 24b and/or the derivative of the common mode current for each section 22 associated with at least one pair of conductors 24a, 24b is/are determined. In one embodiment, the common mode current for each section 22 and/or the derivative of the common mode current for each section 22 is/are recorded.

The vector sum of the current of each section corresponds to a common mode current and can also be called homopolar current.

For example, before a FO (detection of a discharge propagation), during normal operation, the sum of the currents of each section 22 is constant. More generally

$$\frac{{dI}_{i}}{dt} = 0$$

(the derivative of the common mode current I of each section 22) for all sections i.

In step 1010, it is determined whether the common mode current I of each section is above a threshold s (Iᵢ>s>0), or if the derivative of the common mode current I of each section is above a threshold d

$$( \frac{{dI}_{i}}{dt} > d > 0 ) .$$

In this case, the emitting sections are detected.

In another embodiment, all the collecting sections are detected. In this case, the currents and thresholds are negative, for example

$$( {I}_{i} < {s}_{c} < 0 ) or ( \frac{{dI}_{i}}{dt} > {d}_{c} > 0 ) .$$

If

$$\frac{{dI}_{i}}{dt} > d > 0$$

for at least one section 22, with d being a threshold, or if Iᵢ>s>0 for at least one section 22 with s being a threshold, in step 1020 it is determined whether other conditions for a FO are met, in particular if all the conditions are met. In the embodiment where the collecting sections are detected by the comparison indicated above, it is also determined whether other conditions for a FO are met.

The conditions are as follows:
A) if, at the start time of the FO (point A on FIGS. 8 and 9):
a)

$${\sum }_{i = 1}^{N} \frac{{dI}_{i}}{dt} = 0.$$

to noise and measurement uncertainties nearby (equation (2));
b) dI/dt>0 for one section (emitting);
c) dI/dt<0 for at least one other section (collecting);
d) dI/dt=0 for the other sections; and
e) the emitting and collecting sections are all adjacent.

Regarding condition e), for example, if sections 2, 3 and 4 are affected by conditions b) and c), condition e) is met. If sections 1, 3, 4 are affected by conditions b) and c), condition e) is not met.
B) If, from the start time (moment A on FIGS. 8 and 9) to the extinction (moment C on FIGS. 8 and 9) at any time t:
a)

$${\sum }_{i = 1}^{N} \frac{{dI}_{i}}{dt} = 0$$

to noise and measurement uncertainties nearby;
b)

$${\sum }_{i = 1}^{N} {I}_{i} = 0$$

to noise and measurement uncertainties nearby, the sum of the currents I(t), if not directly measured, are calculated by integrating from t0 (start time A on FIGS. 8 and 9) to t;
c) I>0 for one section (emitting);
d) I<0 for at least one other section (collecting);
e) I=0 for the other sections; and
f) the emitting and collecting sections are all adjacent.

Regarding condition e), for example, if sections 2, 3, and 4 are affected by conditions b) and c), condition e) is met. If sections 1, 3, 4 are affected by conditions b) and c), condition e) is not met.
C) If at the time of extinction of the FO (time C on FIGS. 8 and 9):
a) an extinction of the synchronized dI/dt (the times C are at the same moment for all emitting and collecting sections)
dI/dt<0 for one section (emitting);
dI/dt>0 for at least one other section (collecting); and
dI/dt=0 for the other sections.
D) If
the further the collecting sections are from the emitting section, the greater the tpeak (point B′ on FIG. 9),
optional condition: the further the collecting sections are from the emitting section, the lower their dI/dt at the start.

In one embodiment, in particular if the spacecraft is equipped with an electric propulsion device 18, during the start or stop phase of the propulsion device 18, formulas (1) and (2) (cf. conditions A) a), B) a), and B) c)) are modified with the following equations:

$${\sum }_{i = 1}^{N} {I}_{i} = - {I}_{c} , and \qquad ( 1 ’ )$$

$${\sum }_{i = 1}^{N} \frac{{dI}_{i}}{dt} = - \frac{{dI}_{c}}{dt} , \qquad ( 2 ’ )$$

With Ic being the collected current. The collected current Ic between a section of the solar generator 9 and the propulsion device. The collected current Ic can be determined during the start or stop phases without FO. In this case, dIc/dt<0 at the start of the propulsion and dIc/dt>0 at the stop of the propulsion. For the sections 22 that switch, i.e. that alternate between a short-circuited and non-short-circuited state, the signal dIc/dt depends on the switching frequency. The current variation related to the start of the propulsion device 18 is mainly provided by the capacitance of the electrical power bus C_{Bus} (equivalent bus capacity). At the solar generator level, this is reflected by the connection, with an electronic switch, for example, of a section to the power bus, to supply the operating current to the electrical energy consumers and to provide the current necessary to recharge the bus capacitance C_{Bus}.

In an optional step 1030, in case of the detected electrical phenomenon, here the FO, the system, in particular the system for detecting an electrical phenomenon 16 and/or the data processing unit 20 determines one or more of the following: a date of the electrical phenomenon, the solar generator affected by the respective electrical phenomenon, the section 22 emitting the FO, the section(s) 22 collecting the FO, the maximum FO current of the emitting section, the duration of the FO, in particular with the current of the emitting section 22 and/or the time-dependent shape of the FO current with the current of the emitting section.

All or part of this processing can be performed on the spacecraft and completed on the ground, in the data processing unit 20, for example.

In one embodiment, the information is completed, at the time of the electrical phenomenon with the electrical state of the solar generator sections (operating, non-operating, for example, short-circuited, switching), solar generator in eclipse, solar generator illuminated, shading of sections 22, state of the electric propulsion 18, current of one or more sections, and transients of the electric propulsion.

This additional processing can be done on board the spacecraft and/or on the ground, specifically in the data processing unit 20.

This information will enable a distribution of the characteristics of the observed FOs, which will be useful for defining the FO to be simulated during ground classification tests.

This information can also be useful for correlating observed events in flight with the electrical phenomena determined on this spacecraft.

This information can be used to improve theoretical models.

In an optional step 1040, in case of the detected electrical phenomenon, specifically in case of detected FO, the device for detecting an electrical phenomenon 16 is capable of short-circuiting the section 22 emitting the FO and/or the adjacent sections 22 of the section 22 emitting the FO, by the power conditioning unit 14, for example. The number of adjacent sections 22 depends on the distance vis-à-vis the section 22 emitting the FO. This prevents an associated secondary arc and degradation of the solar generator 9. The duration of the short-circuit of the sections 22 depends on the duration of the detected FO and/or the size of the solar generator. For example, the short-circuit duration is at least 10 ms, for example, at least 20 ms.

According to one embodiment, after the short-circuit duration has elapsed, the short-circuited sections 22 are reconnected to the power bus by the power conditioning unit. Thus, the device for detecting an electrical phenomenon 16 is an arc extinction device following the detection of a FO. This arc extinction device following the detection of a FO has the advantage of reducing the duration of secondary arcs in orbit, even if the FO continues its propagation independently, with a duration greater than that of the secondary arcs. This reduces the associated constraints for qualification tests for large-area solar generators.

Aspects of this disclosure enable increasing the differential voltage between solar cells above 30V and increasing the maximum current of a string above 1.5 A.

According to one embodiment, another electrical phenomenon, specifically a (secondary) arc without FO, is detected, triggered by a micrometeoroid and orbital debris (MMOD) impact, for example. Following this detection of a secondary arc, the affected section(s) are short-circuited to extinguish the arc, as described above.

In the case of a secondary arc between cells of different sections 22, the common mode current I of pairs of conductors of the affected sections is not zero, and the sum of the sections is zero, i.e.

$${\sum }_{i = 1}^{N} {I}_{i} = 0.$$

This detection does not work during the start or stop phase of the propulsion device 18.

Thus, the device for detecting an electrical phenomenon 16 is capable of calculating the sum of the common mode currents of the pairs of conductors 24, 24a, 24b. If

$${\sum }_{i = 1}^{N} {I}_{i} = 0 ,$$

the common mode currents of the two sections between which the secondary arc is established are non-zero, one section having a positive common mode current and the other section having a corresponding negative common mode current, and with the common mode currents of the other sections being zero, the device for detecting an electrical phenomenon 16 is capable of determining that there is an arc between two sections without FO.

In the case of a secondary arc between cells of the same section 22, the common mode current of each section is zero, then

$${\sum }_{i = 1}^{N} {I}_{i} = 0$$

and a variation of the common mode current is detected, particularly by the power conditioning unit 14. In this case, the power conditioning unit informs the detection device 16. The detected variation corresponds to a partial or total loss of a string of the affected section, if a blocking diode is used per string, for example. If these conditions are met, the detection device 16 determines that there is an arc between cells of the same section without FO.

In another embodiment, localized arcs between the blocking diodes and the power conditioning unit 14, at the drive mechanism (SADM), for example, are detectable with a current and/or voltage drop on the affected section, by the power conditioning unit 14, for example, or by the device for detecting an electrical phenomenon 16.

In another embodiment, another electrical phenomenon, specifically when a primary arc without FO, such as a blow-off, is detected. This is a discharge of the spacecraft's capacity into space, which can pass through the solar generator's conductor 9. In this case, it is a rapid discharge of the satellite 3's negative charge from a site on the satellite that is not necessarily on a solar generator 9. The solar generators contribute to this global discharge, so a discharge current occurs between the sections and the body 7 of the satellite 3. In this case, the device for detecting an electrical phenomenon determines if Iᵢ<0 for all sections (current towards all sections of the solar generator). If so, the detection device 16 determines that there is a primary arc without FO, whose site is not on a solar generator.

What is claimed is:

1. A system, comprising:
a spacecraft with:
at least one solar generator capable of generating an electric current, each solar generator being covered by a transparent protective material, each solar generator comprising a plurality of sections;
at least one electrical energy consumer, with each solar generator being capable of supplying the electric current to at least one electrical energy consumer of the spacecraft;
at least one pair of electrical conductors associated with each section, to supply the electric current from each section of each solar generator to the respective electrical energy consumers, the pairs of conductors comprising at least one conductor for each polarity;
wherein:
the spacecraft comprises, for each section associated with at least one pair of conductors, at least one sensor to measure a value depending on the current(s) in the conductors; and
the system comprises at least one device for detecting an electrical phenomenon of the solar generator, the device for detecting an electrical phenomenon being capable of:
determining a common mode current for each section and/or the derivative of the common mode current for each section, and
determining the presence of an electrical phenomenon and the section(s) of the solar generator affected by the electrical phenomenon determined from the common mode current of each section and/or the derivative of the common mode current of each section.

2. The system according to claim 1, wherein each solar generator comprises at least two sections.

3. The system according to claim 1, wherein each solar generator forms a photovoltaic wing.

4. The system according to claim 1, wherein the spacecraft is a satellite and/or a space probe.

5. The system according to claim 1, wherein the sensor is a sensor measuring the derivative of a current, particularly a sensor comprising a toroid coil, or a current sensor.

6. The system according to claim 1, comprising exactly one sensor per pair of conductors.

7. The system according to claim 1, wherein the electrical phenomenon is a discharge propagation, a secondary arc, a primary arc without discharge propagation and/or transient currents between solar generator and electric propulsion.

8. The system according to claim 1, wherein the spacecraft is capable of passivating the determined affected section(s), for example by short-circuiting the determined affected section(s).

9. The system according to claim 1, wherein the device for detecting an electrical phenomenon is capable of calculating the sum of all common mode currents of each section and/or calculating the sum of all derivatives of the common mode currents of each section of a solar generator, and using the result of the calculation of the sum of all common mode currents of each section and/or the sum of all derivatives of the common mode currents of each section of a solar generator, the device for detecting an electrical phenomenon being capable of determining the type of electrical phenomenon among a detection of a discharge propagation, a secondary arc, a primary arc without discharge propagation and/or transient currents between solar generator and electric propulsion.

10. The system according to claim 1, wherein the spacecraft comprises a power conditioning unit and in that the power conditioning unit comprises the sensors.

11. The system according to claim 1, wherein at least one device for detecting an electrical phenomenon of the solar generator is arranged on the ground.

12. The system according to claim 1, wherein at least one device for detecting an electrical phenomenon of the solar generator is arranged in the spacecraft.

13. The system according to claim 1, wherein a first part of a device for detecting an electrical phenomenon of the solar generator is arranged in the spacecraft and a second part of the device for detecting an electrical phenomenon of the solar generator is arranged on the ground.

14. A method for determining an electrical phenomenon of a solar generator of a spacecraft with:
at least one solar generator capable of generating an electric current, each solar generator being covered by a transparent protective material, each solar generator comprising a plurality of sections;
at least one electrical energy consumer, each solar generator being capable of supplying the electric current to at least one electrical energy consumer of the spacecraft;
at least one pair of electrical conductors associated with each section to supply the electrical energy from each section of each solar generator to the respective electrical energy consumers, the pairs of conductors comprising at least one conductor for each polarity;
the method comprising:
obtaining a measurement in each pair of conductors, a value depending on the current(s) in the conductors; and
determining the common mode current for each section and/or the derivative of the common mode current for each section, and
determining the presence of the electrical phenomenon and the section(s) of the solar generator affected by the electrical phenomenon, from the common mode current of each section and/or the derivative of the common mode current of each section.
